(19) United States
(12) Patent Application Publication
(10) Pub. No.: US 2026/0317603 A1
(43) Pub. Date: Oct. 15, 2026

(54) COMPOSITIONS AND METHODS OF PRODUCING A CREPE PAPER

(71) Applicant: SOLENIS TECHNOLOGIES, L.P., Wilmington, DE (US)

(72) Inventors: Michael A. Evans, Newark, DE (US); Andrew M. Rogers, Coatesville, PA (US)

(73) Assignee: SOLENIS TECHNOLOGIES, L.P., Wilmington, DE (US)

(21) Appl. No.: 19/466,675

(22) Filed: Feb. 2, 2026

Related U.S. Application Data
(60) Provisional application No. 63/757,363, filed on Feb. 12, 2025.

(51) Int. Cl. C09J 199/00; B31F 1/12; C09J 11/06; C09J 11/08

(52) U.S. Cl. CPC C09J 199/00; B31F 1/12; C09J 11/06; C09J 11/08

(57) ABSTRACT

The present disclosure generally relates to the making of a crepe paper product. More particularly, provided are compositions and methods for producing a crepe paper having improved adhesion and release properties. The composition is an adhesive formulation comprising a plant or algae based protein source, one or more modifying agents, and optionally one or more release agents. The composition is applied to a drum dryer in a crepe paper making process thereby providing improved adhesion and release properties of the paper from the drum dryer.

### CROSS-REFERENCE TO RELATED APPLICATIONS

This application claims the benefit of U.S. Provisional Patent Application No. 63/757,363, filed 12 Feb. 2025, the entire contents of which are hereby incorporated by reference.

### TECHNICAL FIELD

The present disclosure generally relates to compositions and methods for producing a crepe paper having improved adhesion and release properties. In particular, the composition is an adhesive formulation comprising a plant or algae based protein source, one or more modifying agents, and optionally one or more release agent. The composition is applied to the drum dryer in a crepe paper making process thereby providing improved adhesion and release properties of the paper from the drum dryer.

### BACKGROUND

Provided is a new, cost-effective, and sustainable adhesive for producing creped paper. In the process of making paper products that include tissue and towel, a suspension of cellulose fibers in water is filtered through a screening fabric in the forming section of the paper machine forming a fibrous web. The web formed must then be dried. Although a variety of drying configurations exist, and the majority of these involve drying the sheet on a large drum drier known in the industry as a Yankee drier. In order to improve the bulk softness of the final product, the sheet is typically disrupted by lightly adhering the fibers to the surface of the Yankee. The adhered sheet is then scraped off the Yankee at high speed using a doctor blade. This process is known as creping the sheet, and the resulting folds give the sheet both softness and stretchability.

The adhesive used for the creping process must be finely tuned to meet a number of requirements. Adhesion must be strong enough as to facilitate fiber disruption, but not so strong as to cause picking holes or total failure of the paper. Furthermore, the adhesive should be soft enough as to allow the doctor blade to ride smoothly over the surface without chatter, but not so soft as to embed and permanently retain fibers from the sheet. Typically, the system should exhibit a cohesive failure such that an extremely thin layer of the adhesive remains on the Yankee surface in order to protect the asset. However, it is important that the coating does not continue to build up on the drum dryer or Yankee cylinder.

Another consideration for tuning the Yankee adhesive is that it must be very efficient. In this context, high efficiency means that very small amounts of adhesive are required to accomplish the task. This is not only important for keeping process costs low, but it also helps retain drier efficiency. If the coating becomes too thick, it will impede heat transfer. Without effective heat transfer, the operation must be slowed down to allow sufficient tissue drying time. Since drying tends to be the rate-limiting step in the papermaking process, drier speed is critical to having a high production capacity.

Yet another factor in formulating a crepe adhesive is wet-tack. Yankee adhesives are generally applied in a continuous fashion by spraying a dilute aqueous solution directly onto the Yankee surface. As the water flashes off, the remaining adhesive must exhibit a slightly sticky characteristic in order to facilitate transfer of the wet sheet from the felt conveyor onto the drier. If there is not sufficient tack, the sheet may slip, or it may not reach it is adhesion potential.

Finally, a good creping adhesive will also be compatible with a wide range of release and coating modifiers. These are necessary components of the coating package which offer customer-specific fine tuning directly in the ongoing operation. Release agents not only help temper adhesion, but they also provide friction reduction which can aid in asset protection and smoother creping operations. There are a wide range of materials which may serve as adhesion modifiers, and it is important that the creping adhesive is both responsive but also not catastrophically disrupted by the presence of such materials.

Therefore, in many applications, a good crepe adhesive must meet a wide range of stringent requirements beyond being cost-effective and regulatory compliant. The adhesive composition should provide the correct level of adhesion depending on the specific application. For example, some producers may only use 2-3 mg/m³ of an adhesive, wherein a typical application for a light-dry crepe (LDC) process may be 4-5 mg/m³, while others might employ as much as 9-10 mg/m³. Furthermore, in premium tissue and towel grades, the use of a Through-Air-Drying (TAD) step prior to the Yankee creping process may impart a structure in the sheet. These textured sheets typically require greater adhesive dosages and may employ upwards of 30 mg/m³ of adhesive to ensure adequate adhesion of the partly dried sheet. Finally, needed was an adhesive composition that exhibits enough tack as to allow effective sheet transfer and compatibility with coating modifiers as to allow for dosage adjustments. Currently, the vast majority of creping adhesives are created from synthetic polymers, and there remains a need and demand for adhesives created from environmentally friendly and renewable raw materials.

Accordingly, it is desirable to provide compositions and methods that offers all of the qualities outlined above. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is an adhesive composition for creping paper that includes one or more plant, or algae based protein sources, one or more modifying agents, and optionally one or more release agents. The plant or algae based protein source is in the form of, for example, seaweed, spirulina, soy, sunflower seed, peanut, almond, pea, bean, wheat and combinations thereof. Furthermore, the protein may be employed as a flour, a concentrate, an isolate, and combinations thereof.

Also, provided is a method of producing a crepe paper utilizing a protein-based creping adhesive. The process yields creped products with strength, softness, and stretch properties which are equivalent or superior to traditional synthetic adhesives whilst also being sustainable and cost efficient.

The method includes treating the drum dryer or Yankee dryer (used interchangeably) with a composition that includes a plant, or algae based protein source, a modifying agent and optionally a release agent. The adhesive composition can be applied to the fibrous web immediately preceding the fibrous web being contacted with the surface of the drum dryer, the composition can be applied to the surface of the drum dryer, or the composition could be applied to both the fibrous web and the drum dryer. The compositions were found to have improved adhesion and release properties from the drum dryer to produce the desired crepe paper product.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Furthermore, there is no intention to be bound by any expressed or implied theory presented in the preceding technical field, background, brief summary, or the following detailed description.

Unless specifically stated or obvious from context, as used herein, the term “about” is understood to be within a range of normal tolerance in the art, for example within 2 standard deviations of the mean. “About” can be understood as being within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about”.

It was found in the current work that fibrous webs can be creped using a formulation that includes one or more plant, or algae based protein sources, one or more modifying agents, and optionally one or more release agents. The composition can be applied to the drying surface of a drum dryer or Yankee dryer, directly to the fibrous web prior to the drum dryer, or a combination thereof. The fibrous web is pressed against the surface of the drum dryer to effect adhesion of the web to the drying surface. A “creping” device, such as a doctor blade, is used to remove and crepe the fibrous web or paper.

Provided is an adhesive composition for creping paper that includes one or more plant, or algae based protein sources; one or more modifying agents, and optionally one or more release agent.

In some aspects of the composition, the plant or algae based protein source can be in the form of seaweed, spirulina, soy, sunflower seed, peanut, almond, pea, bean, wheat and combinations thereof. Furthermore, the protein may be employed as a flour, a concentrate, an isolate, and combinations thereof.

In some aspects of the adhesive composition, the protein is present in an amount of from about 5 wt. % to about 90 wt. %, or from about 10 wt. % to about 60 wt. %, or from 15 wt. % to about 45 wt. % of the total composition.

In some aspects of the adhesive composition, the one or more modifying agents comprises viscosity stabilizers, plasticizers, humectants, microbiological agents, dispersants and surfactants, and combinations thereof.

In other aspects of the composition, the modifying agent is a plasticizer chosen from glycerol, 1,2-propylene glycol, 1,3-propylene glycol, dipropylene glycol, polyethylene glycol, polypropylene glycol, PEG-PPG copolymers, sugar such as, for example, sucrose and/or glucose, syrups (ex. corn syrup), urea, dimethylurea, and combinations thereof.

In other aspects of the adhesive composition, the modifier is a dispersant/surfactant that is chosen from fatty esters and fatty ethers of polyethylene glycol, polypropylene glycol, PEG-PPG copolymers, and combinations thereof. These fatty components include, but are not limited to, saturated and unsaturated hydrocarbons, typically containing 6 to 22 carbons.

In some aspects of the adhesive composition, the modifier is an ionic surfactant. These may include deprotonated fatty acids such as, but not limited to, stearic, oleic, linoleic, and tall oil fatty acids. The ionic surfactant may also include deprotonated sulfates & sulfonates such as, but not limited to, sodium lauryl sulfate, sodium laureth sulfate, and/or dioctyl sodium sulfosuccinate. [0024] In some aspects of the adhesive composition, the modifier is a synthetic polymer such as, but not limited to, polyvinyl alcohol (PVOH), PVAm/PVOH copolymers, polyvinyl acetate, polyvinylacrylic acid, polyamidoamines, polyethyleneimines, polyvinylpyrrolidone, polystyrene-maleic anhydride, and combinations thereof.

In yet other aspects of the composition, the optional one or more release agents are present and chosen from oils, waxes, trimethylolpropane trioleate (TMPTO), fatty imidazolines, surfactants, and combinations thereof.

In other aspects of the composition, the optional one or more release agents are present and is an oil chosen from paraffin, naphthalene, tall oil, mineral oil, vegetable, silicone, and combinations thereof.

In other aspects of the optional one or more release agents is present in an amount of from about 5 wt. % to about 90 wt. %, or from about 20 wt. % to about 70 wt. % of the total composition.

In some aspects of the adhesive composition, the modifier alone or in combination with the release agent is present in an amount of from about 5 wt. % to about 90 wt. %, or from about 20 wt. % to about 70 wt. % of the total composition.

In some aspects of the adhesive composition, the composition further comprises a crosslinker chosen from polyamidoamine-epichlorohydrin (PAE), glyoxylated polyacrylamide (GPAM) resins, polyethyleneimine (PEI), polyvinylamine (PVAm), polyvinyl alcohol (PVOH)/PVAm copolymers, epichlorohydrin, glutaraldehyde, isocyanates (ex. HDI, MDI, and water dispersible variants of these materials), di-/tri-/polyglycidyl ethers, formaldehyde, urea-formaldehyde resins, and combinations thereof. The aforementioned materials may crosslink via covalent bonding, ionic bonding, or a combination thereof.

In other aspects of the adhesive composition, the composition further includes a crosslinker in an amount of from about 0.5 wt. % to about 10 wt. %, or from about 1 wt. % to about 5 wt. % of the total composition.

In other aspects of the adhesive composition, the composition further comprises a biocide. Examples of effective biocides include, but are not limited to, isothiazolinones (ex. Methylisothiazolinone, benzoisothiazolinone, and 5-chloro-2-methyl-4-isothiazolin-3-one), 2-bromo-2-nitropropane-1,3-diol, sodium tetraborate, sodium nitrate, sodium nitrite, and combinations thereof.

Also, provided is a method of producing a crepe paper utilizing a protein-based creping adhesive. The process yields creped products with strength, softness, and stretch properties which are equivalent or superior to traditional synthetic adhesives whilst also being sustainable and cost efficient. The method includes treating the drum dryer or Yankee dryer (used interchangeably) with a composition that includes one or more plant, or algae based protein sources; one or more modifying agents, and optionally one or more release agents. Although, the composition is generally applied to the surface of the drum dryer thereby providing improved adhesion and release properties from the drum dryer, the composition can be applied to the pulp or fibrous web prior to the drum dryer or a combination of both. This results in improved adhesion/release properties of the formed paper from the drum dryer. In some instances, the formed fibrous web can be treated immediately prior to contact with the drum dryer.

In some aspects of the method, prior to applying the adhesive composition to the fibrous web and/or drum dryer, the temperature of the composition can be adjusted to from about 65° C. to about 110° C., and the pH to about 8 to about 11 prior to the composition being applied to the fibrous web and/or drum dryer.

In other aspects of the method, the temperature of the composition is adjusted to a temperature of from about 65° C. to about 110° C. and a pH of about 10 to about 12 for from about 15 seconds to about 240 minutes, and prior to the composition being applied to the fibrous web and/or drum dryer, the pH can be optionally readjusted to a pH of about 7 to about 9.

In yet other aspects of the method, the adhesive composition may be heated and held at high temperatures and pressures for a brief period of time. In doing this it is possible to destroy microorganisms and their spores without degrading the adhesive composition. For example, the soy composition can be cooked (held at temperature) for about 15 to about 60 seconds at 110° C. to 130° C. using a jet-cooker, which preserves the composition and prevents biological degradation.

In some aspects of the method, the plant or algae based protein source is in the form of an isolate, a protein concentrate, and/or flour and may be treated with an enzyme to improve film forming and adhesion properties of the composition. These enzymes may modify the protein component and/or carbohydrate component.

In yet other aspects of the method, the adhesive composition is diluted with water prior to use, and this aqueous solution can be sprayed onto the drum dryer or directly onto the formed wet fibrous web just prior to the Yankee. In this instance, the protein source is present in an amount of from about 0.1 wt. % to about 10 wt. % of the total adhesive composition, or from about 0.25 wt. % to about 5 wt. %, or from about 0.5 wt. % to about 2 wt. % of the total adhesive composition.

In some aspects of the method, the fibrous web and/or drum dryer is treated with the adhesive composition, on a dry weight basis, in an amount of from about 0.001 wt. % to about 0.005 wt. % based on the dry weight of the pulp or paper being produced. The maximum amount of creping adhesive used is about 2 wt. %, or about 1 wt. %, or about 0.25 wt. % relative to the crepe paper being formed.

In some aspects of the method, the composition is applied to the fibrous web or drum dryer by spraying, brushing, rolling, foam applications, and combinations thereof. The composition could be applied to the web prior to dewatering, or the composition could be applied directly onto the sheet immediately preceding the paper making contact with the drum dryer.

In yet other aspects of the method, the composition is added to the pulp before formation of the sheet.

### EXAMPLES

### Adhesion Testing Process:

The following adhesion testing is evaluated via a lap-sheer testing method using an Automated Bonding Evaluation System (ABES) manufactured by Adhesive Evaluation Systems. (AES) The method involves treating the end of two stainless steel plates with a dilute adhesive solution by utilizing an ultrasonic spray nozzle. The specimens are placed on a reciprocating sample holder, and they are passed under the nozzle for multiple passes. The samples are partially dried between coatings by blowing nitrogen over them to ensure an even coating on the specimen without excessive water buildup. Typically, the adhesive solutions are diluted such that the final amount of adhesive deposited on the specimen is reflective of the amount of adhesive used in a typical creping operation. Once the two specimens are treated with adhesive, a half-inch wide strip of 25 gsm uncreped tissue with 50% moisture content, is placed on the adhesive film on one of the two samples. The other specimen is then oriented such that the tissue sample is sandwiched between the adhesive films. This assembly is then placed in the ABES unit. The ABES method is designed to press the bond-line between two hot platens for a set amount of time. (Typically 105-115° C. for 2-4 minutes) The hot platens then retract, and the newly formed bond is tested by immediately pulling it and recording the breaking strength while it is still hot.

### Crepe Simulation:

During the development of crepe adhesives, a crepe simulator is employed as a means to evaluate creping performance. This is a custom-designed piece of equipment which consists of a heated steel drum dryer used to model a Yankee drum dryer, an adhesive applicator, an uncreped tissue transfer roll, and an articulating doctor blade. In a typical operation, the steel drum dryer is heated to between about 105° C. and 115° C., and a dilute (0.5-2.0%) solution of an adhesive composition is sprayed onto the drum as it slowly rotates. Within seconds, a 22″×3.75″ strip of uncreped tissue is transferred from the tissue transfer roll onto the steel drum dryer. In order to facilitate transfer and proper adhesion, the uncreped tissue is first sprayed with water to increase its moisture content. Once the sheet has been transferred to the dryer, the rotational speed of the drum is increased until its surface speed is in the range of a typical tissue manufacturing operation, e.g., from about 1000 m/min to 2200 m/min. During this ramp up in speed, the tissue paper is dried to a moisture content of about 2%. Finally, a doctor blade mounted on an automated articulating sled is triggered to come into contact with the drum dryer, causing the adhered sheet to become dislodged from the dryer and creped in the process. This tissue is measured for crepe vs. uncreped length, stretched crepe length, tensile strength, and TSA softness.

### Example 1

A 1-liter (L) jacketed reactor vessel was fitted with an overhead mixer, a thermocouple, and a condenser. The reactor was then charged with glycerol, sugar, and/or com syrup followed by water in a predetermined ratio as defined by Table 1. As the vessel mixed, Prolia® 200/70 soy flour (Cargill Inc.) was carefully added. The composition was then cooked for a period of time, i.e., the composition inside the vessel was heated to about 85° C. and mixed for 30 minutes. In samples IC-IF, urea was added after this cook period. The composition was then cooled to room temperature, and 0.25% of Proxel® GXL was added as a preservative. Adhesion was then evaluated using the aforementioned ABES testing method.

TABLE 1
Formulations for ABES Adhesion Testing

| | | | | | | | | ABES Data | |
|---|---|---|---|---|---|---|---|---|---|
| | Weight Ratios | | | | | | | | 99% |
| | | | | | | Light | Dark | | Con- |
| | | | | | | Corn | Corn | Ad- | fi- |
| Sam- | Gly- | Wa- | Soy | Ur- | Su- | Syr- | Syr- | he- | dence |
| ple | cerol | ter | Flour | ea | gar | up | up | sion | Level |
| 1A | 1 | 4.67 | 1 | — | — | — | — | 76 | 5.0 |
| 1B | 2 | 4.50 | 1 | — | — | — | — | 60 | 4.5 |
| 1C | 1 | 7.00 | 1 | 1 | — | — | — | 69 | 4.5 |
| 1D | 1 | 7.43 | 2 | — | 1 | — | — | 74 | 4.2 |
| 1E | 1 | 7.43 | 2 | — | — | 1 | — | 79 | 6.2 |
| 1F | 1 | 7.43 | 2 | — | — | — | 1 | 84 | 5.5 |

| | | | |
|---|---|---|---|
| Con- | Standard Non-Thermosetting | 31 | 4.2 |
| trol | Polyamide Creping Adhesive | | |

T
1
?

### Example 1.1

The adhesive formulation described in Sample IA was evaluated on a crepe simulator as described in the aforementioned crepe simulator method. In this study, the material was qualitatively compared to a typical Yankee adhesive coating package comprised of a commercially available crepe adhesive, Crepetrol® 3222 from Solenis LLC, and a commercially available release agent, Rezosol® 3280 also from Solenis LLC. The control coating was adjusted for optimal performance on this crepe simulator. In this case, the coating package was sprayed as a 1% solution containing 7 parts adhesive to 3 parts release agent.

When compared to the protein adhesive described in Example 1, Sample IA, it was found that the protein adhesive was also compatible with the Rezosol® 3280 release. Furthermore, it was also discovered that the total amount of the composition of Sample IA could be reduced by 50% if the release agent was removed from the coating package. In both of these cases, the protein-based crepe adhesive provided a crepe tissue sample with qualities nearly identical to that of the traditional PAE-based crepe adhesive coating package.

### Example 2

A 1-liter (L) jacketed reactor vessel was fitted with an overhead mixer, a thermocouple, and a condenser. The reactor was then charged with water and Prolia® 200/70 in a 5.66 to 1 ratio with mixing. The vessel was then heated to 85° C., and it was mixed at this temperature for 30 minutes. The vessel was then cooled to room temperature, and 0.25% of Proxel® GXL was added as a preservative. In order to understand the impact of plasticizer, adhesion was then evaluated using the aforementioned ABES testing method. In these experiments, the protein adhesive and the plasticizers were diluted to 1% stock solutions. These were then combined in the necessary ratios as defined by the samples in Table 2. This solution was further diluted down to 0.125% before spraying in the ABES method.

TABLE 2
ABES Adhesion Testing

| | | | ABES Data | |
|---|---|---|---|---|
| | Plasticizer | | | 95% |
| | | % of | | Confidence |
| Sample | Type | Adhesive | Adhesion | Level |
| 2A | — | 0.0 | 100 | 5.5 |
| 2B | Glycerol | 9.1 | 110 | 7.2 |
| 2C | Glycerol | 20.0 | 115 | 7.4 |
| 2D | Glycerol | 33.0 | 77 | 5.9 |
| 2E | Glycerol | 50.0 | 63 | 4.0 |
| 2F | PEG200 | 9.1 | 116 | 4.3 |
| 2G | PEG200 | 20.0 | 99 | 4.5 |
| 2H | PEG200 | 33.0 | 82 | 6.6 |
| 2I | PEG200 | 50.0 | 79 | 6.0 |
| 2J | PEG2k | 9.1 | 97 | 6.0 |
| 2K | PEG2k | 20.0 | 109 | 3.8 |
| 2L | PEG2k | 33.0 | 90 | 7.6 |
| 2M | PEG2k | 50.0 | 76 | 6.6 |
| 2N | PEG10k | 9.1 | 91 | 6.9 |
| 20 | PEG10k | 20.0 | 97 | 5.9 |
| 2P | PEG10k | 33.0 | 97 | 6.2 |
| 2Q | PEG10k | 50.0 | 79 | 5.3 |

These results indicate that the protein-based creping adhesives are compatible with a broad range of modifiers and in a broad range of ratios. This flexibility allows for fine tuning of the adhesive's creping characteristics which can therefore be uniquely optimized for specific creping assets, conditions, and paper grades.

### Example 3

A 1-L jacketed reactor vessel was fitted with an overhead mixer, a thermocouple, and a condenser. The reactor was then charged with one part glycerol and 4.67 parts water. As the vessel mixed, one part of Prolia® 200/70 soy flour was carefully added. Optionally, the pH was adjusted to 11 using a 10% potassium hydroxide solution. The vessel was then heated to the target temperature for the designated time as described by Table 3. The vessel was then cooled to room temperature, and 0.17% of Proxel® GXL was added as a preservative. The samples which were pH adjusted to 11, were then readjusted back to pH=8.0 using 10% sulfuric acid. Adhesion was then evaluated using the aforementioned ABES testing method.

TABLE 3
ABES Adhesion Testing

| | Cook Specifications | | | ABES Data | | |
|---|---|---|---|---|---|---|
| | | | | | 95% | |
| | | Time | pH | | Confi- | |
| Sam- | Temper- | (Min- | Ad- | Adhe- | dence | Sta- |
| ple | ature | utes) | just | sion | Level | bility |
| 3A | 25° C. | 60 | No | — | — | Settles |
| | | | | | | in 24 h |
| 3B | 25° C. | 60 | Yes | 60 psi | 4.7 | Settles |
| | | | | | | in 24 h |
| 3C | 50° C. | 60 | Yes | 59 psi | 3.4 | Settles |
| | | | | | | in 24 h |
| 3D | 95° C. | 30 | Yes | 62 psi | 3.5 | Stable |
| 3E | 95° C. | 60 | Yes | 45 psi | 3.9 | Stable |
| 3F | 95° C. | 180 | Yes | 30 psi | 3.0 | Stable |
| 3G | 95° C. | 240 | Yes | — | — | Stable |
| 3H | 110° C. | 30 | Yes | — | — | Stable |

Results demonstrate that the cooking process affects both adhesion and product stability. For example, in the case of Prolia® 200/70, heating may not be necessary for building adhesion provided a pH adjustment is included. However, the formulation was more prone to settling.

Products produced at 95° C. were particularly attractive as they were viscometrically stable, resistant to settling, and the elevated temperatures deactivated many of the spores present in the flour. However, prolonged cooking at 95° C. and elevated pH does result in a decay in adhesion as seen in samples 3D-3G. Finally, when temperatures are further increased, as in example 3H, adhesion was also greatly reduced.

### Example 4

A 1-L jacketed reactor vessel was fitted with an overhead mixer, a thermocouple, and a condenser. The reactor was then charged with one part glycerol and 4.67 parts water. As the vessel mixed, one part of Prolia® 200/70 soy flour was carefully added. Optionally, the first pH adjustment was made as described by Table 4. The vessel was then heated to 85° C. and held at this temperature for 30 minutes. The vessel was then cooled to room temperature, and a final pH adjustment was made as described in Table 4. Finally, 0.25% of Proxel® GXL was added as a preservative. Adhesion was evaluated using the aforementioned ABES testing method.

TABLE 4
ABES Adhesion Testing

| | | | Final pH | | | |
|---|---|---|---|---|---|---|
| | First pH | | adjustment | | | |
| | Adjustment | | | Fi- | ABES Data | |
| | | Target | | nal | | Target |
| Sample | Reagent | pH | Reagent | pH | Reagent | pH |
| 4A | 10% | 4.0 | — | 4A | 10% | 4.0 |
| | H₂SO₄ | | | | H₂SO₄ | |
| 4B | — | As | — | 4B | — | As |
| | | Made | | | | Made |
| 4C | 10% | 8.0 | — | 4C | 10% | 8.0 |
| | KOH | | | | KOH | |
| 4D | 10% | 11.0 | — | 4D | 10% | 11.0 |
| | KOH | | | | KOH | |
| 4E | 10% | 11.0 | 10% | 4E | 10% | 11.0 |
| | KOH | | HC1 | | KOH | |
| 4F | 10% | 11.0 | 10% | 4F | 10% | 11.0 |
| | KOH | | H₂SO₄ | | KOH | |
| 4G | 10% | 11.0 | 10% | 4G | 10% | 11.0 |
| | KOH | | H₃PO₄ | | KOH | |
| 4H | 10% | 11.0 | 10% | 4H | 10% | 11.0 |
| | NaOH | | H₂SO₄ | | NaOH | |

Results demonstrate that the performance of the protein-based adhesives can be further optimized via pH adjustment. In this case, it was found that adhesion performance could be significantly enhanced over the “As Made” Sample 4B by elevating the pH to 11.0 using either potassium or sodium hydroxide prior to cooking. (Sample 4D) Furthermore, this performance enhancement could be maintained even if the pH was then reduced back to 8.0 using sulfuric acid. (Samples 4G & 4H) This could be considered unexpected considering that the sample which was simply maintained at pH 8.0 (Sample 4C) did not perform as well as the unadjusted Sample 4B. These formulations demonstrated excellent stability as well. It was also noted that at formulations produced at pH 4.0 (Sample 4A) demonstrated significantly reduced adhesion. Samples 4E-4G demonstrate the effect of the acid counterion on performance. This body of work indicates the importance of optimizing the pH profile when developing protein-based creping adhesives.

### Example 5

A 1-L jacketed reactor vessel was fitted with an overhead mixer, a thermocouple, and a condenser. The reactor was then charged with one part glycerol and 4.67 parts water. As the vessel mixed, one part of Prolia® 200/70 soy flour was carefully added. The vessel was then heated to 85° C. and held at this temperature for 30 minutes. The vessel was then cooled to room temperature, and 0.25% of Proxel® GXL was added as a preservative. Adhesion was evaluated using the aforementioned ABES testing method. In these experiments, the protein adhesive and the crosslinkers were diluted to 1% stock solutions. These were then combined in the ratios as defined in Table 5, Samples 5A-5H. In the cases where a pH adjustment was performed, a 2% solution of sulfuric acid was first used to adjust the pH of protein adhesive prior to combination with the crosslinker. The resulting combined solutions were further diluted down to 0.125% before spraying in the ABES method.

TABLE 5
ABES Adhesion with Crosslinker

| | | | ABES Adhesion with | | | |
|---|---|---|---|---|---|---|
| | | pH | X % Crosslinker | | | |
| Example | Crosslinker | Adjust | 0 | 2 | 5 | 10 |
| 5A | Low AZE | — | 79 | Unstable Spray | | |
| | PAE | | | Formulation | | |
| 5B | High AZE | — | 79 | Unstable Spray | | |
| | PAE | | | Formulation | | |
| 5C | Low | — | 79 | Unstable Spray | | |
| | Hydrolysis | | | Formulation | | |
| | PVAm | | | | | |
| 5D | 33% | — | 79 | Unstable Spray | | |
| | Hydrolysis | | | Formulation | | |
| | PVAm | | | | | |
| 5E | Low AZE | 4.25 | 67 | 102 | 120 | 117 |
| | PAE | | | | | |
| 5F | High AZE | 4.25 | 67 | 107 | 129 | 125 |
| | PAE | | | | | |
| 5G | 33% | 4.25 | 67 | 128 | 134 | 135 |
| | Hydrolysis | | | | | |
| | PVAm | | | | | |
| 5H | 50% | 4.25 | 67 | 120 | 133 | 131 |
| | Hydrolysis | | | | | |
| | PVAm | | | | | |

The results in Table 5, demonstrate that under optimal conditions, adhesion can be dramatically improved with the addition of a cationic crosslinker. However, adjustments must be made in order to accommodate these materials with a protein-based adhesive. If a native-pH soy-flour based adhesive is introduced to a cationic material such as a PAE or PVAm, the dilute spray solution is unstable. The cationic materials causes aggregation and settling of the net-anionic soy protein particles. This is undesirable, as these aggregates may be clog a spray nozzle, or the active adhesive may be removed by in-line filters on the way to the application nozzle. To avoid this aggregation, the pH of the spray solution should be reduced below the isoelectric point of the protein. Consistent with Example 4, a loss of adhesion is observed when the pH is reduced. (Sample 5A-0% Crosslinker vs. Sample 5E-0% crosslinker) However, this loss is significantly overcome with the introduction of the crosslinkers described in Samples 5E-5H). It should be noted that the Low-Azetidinium (AZE) PAE in Sample 5E serves to represent a typical polyamidoamine-based creping adhesive. The High-AZE PAE in Sample 5F is representative of a polyamidoamine epichlorohydrin-based wet strength resin. Samples 5G and 5H demonstrate that a range of polyvinylamine-based crosslinkers are also very efficient crosslinkers. Finally, the hydrolysis level of these materials can impact the efficiency of these crosslinkers.

### Example 6

A 1-L jacketed reactor vessel was fitted with an overhead mixer, a thermocouple, and a condenser. The reactor was then charged with one part glycerol and 4.67 parts water. As the vessel mixed, one part of Prolia® 200/70 soy flour was carefully added. The pH of this blend was adjusted to pH 11 using a 10% solution of potassium hydroxide. The vessel was then heated to 85° C. and held at this temperature for 30 minutes. The vessel was then cooled to room temperature, and the pH was adjusted to 8.00 using 10% sulfuric acid. Finally, 0.25% of Proxel® GXL was added as a preservative. Adhesion was evaluated using the aforementioned ABES testing method. In these experiments, the protein adhesive and the crosslinkers were diluted to 1% stock solutions. These were then combined in the necessary ratios as defined by the examples in Table 6. The resulting combined solutions were further diluted down to 0.125% before spraying in the ABES method.

TABLE 6
ABES Adhesion with Crosslinker

| | | ABES Adhesion | | | | |
|---|---|---|---|---|---|---|
| | | with X% Crosslinker | | | | |
| Example | Crosslinker | 0 | 1 | 2 | 5 | 10 |
| 6A | Anionic | 61 | 70 | 80 | 72 | 73 |
| | GPAM | | | | | |
| 6B | PEG500 | 61 | 71 | 70 | 73 | 76 |
| | diglycidyl | | | | | |
| | ether | | | | | |

Example 6, demonstrates an alternative way to crosslink the protein-based adhesives while avoiding the need to adjust the pH for stability as was described in Example 5. If anionic or nonionic crosslinkers are employed, then enhancements in adhesion may be observed without any need to reduce the pH of the adhesive. This is because the charge on soy flour is net-anionic when at its native pH or above. The charge-induced aggregation observed in Example 5 does not occur with these neutral or anionic of crosslinkers.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. An adhesive composition for creping paper comprising:
a plant or algae based protein source;
one or more modifying agents; and
optionally one or more release agents.

2. The adhesive composition according to claim 1, wherein the plant or algae based protein source is in the form of seaweed, spirulina, soy, sunflower seed, peanut, almond, pea, bean, wheat, and combinations thereof.

3. The adhesive composition according to claim 1, wherein the protein source is present in an amount of from about 5 wt. % to about 90 wt. %, or from about 10 wt. % to about 60 wt. %, or from 15 wt. % to about 45 wt. % of the total composition.

4. The adhesive composition according to claim 1, the modifying agent is chosen from plasticizers, dispersants and surfactants, synthetic polymers, viscosity stabilizers, humectants, microbiological agents, and combinations thereof.

5. The adhesive composition according to claim 4, wherein the modifying agent is a plasticizer is chosen from glycerol, 1,2 propylene glycol, 1,3 propylene glycol, polyethylene glycol, polypropylene glycol, PEG-PPG copolymers, sugar, syrups, starches, urea, dimethylurea, triethyl citrate, acetin, lecithin, and combinations thereof.

6. The adhesive composition according to claim 4, wherein the dispersants and surfactants are chosen from fatty esters, fatty ethers of polyethylene glycol, polypropylene glycol, PEG-PPG copolymers, and combinations thereof.

7. The adhesive composition according to claim 6, wherein the fatty esters and fatty ethers are chosen from saturated and unsaturated hydrocarbons containing 6 to 22 carbons.

8. The adhesive composition according to claim 4, wherein the dispersants and surfactants is an ionic surfactant chosen from deprotonated fatty acids, deprotonated sulfates, deprotonated sulfonates, and combinations thereof.

9. The composition according to claim 4, wherein the synthetic polymer is chosen from polyvinyl alcohol (PVOH), PVAm/PVOH copolymers, polyvinyl acetate, polyvinyl acrylic acid, polyamidoamines, polyethyleneimines, polyvinylpyrrolidone, polystyrene-maleic anhydride, and combinations thereof.

10. The adhesive composition according to claim 1, wherein the modifying agent is present in an amount of from about 5 wt. % to about 90 wt. %, or from about 20 wt. % to about 70 wt. % of the total composition.

11. The adhesive composition according to claim 1, wherein the one or more optional release agents are present and chosen from oils, waxes, trimethylolpropane trioleate (TMPTO), fatty imidazolines, surfactants, and combinations thereof.

12. The adhesive composition according to claim 1, wherein the optional one or more release agents is present in an amount of from about 5 wt. % to about 90 wt. %, or from about 20 wt. % to about 70 wt. % of the total composition.

13. The adhesive composition according to claim 1, further comprising a crosslinker.

14. The adhesive composition according to claim 13, wherein the crosslinkers are chosen from polyamidoamine-epichlorohydrin (PAE), glyoxylated polyacrylamide (GPAM) resins, polyethyleneimine (PEI), polyvinylamine (PVAm), polyvinyl alcohol (PVOH)/PVAm copolymers, epichlorohydrin, glutaraldehyde, isocyanates (ex. HDI, MDI, and water dispersible variants of these materials), di-/tri-/polyglycidyl ethers, formaldehyde, urea-formaldehyde resins, and combinations thereof.

15. The adhesive composition according to claim 13, wherein the crosslinker is a glyoxylated polyacrylamide (GPAM) that carries an anionic charge.

16. The adhesive composition according to claim 13, wherein the crosslinker is present an amount of from about 0.5 wt. % to about 10 wt. %, or from about 1 wt. % to about 5 wt. % of the total composition.

17. A method of producing a crepe paper having improved adhesion and release properties from a drum dryer in a crepe paper producing process comprising:
providing a composition comprising: a plant or algae based protein source, one or more modifying agents, and optionally one or more release agents;
applying the composition to a fibrous web immediately preceding the contacting of the surface of the drum dryer, applying the composition to the surface of the drum dryer, or a combination thereof, and
producing a crepe paper product.

18. The method according to claim 17, wherein the plant or algae based protein source is provided as a solution and heated to at a temperature of about 50° C. to 140° C., and held at that temperature for from about 15 seconds to about 240 minutes.

19. The method according to claim 17, wherein the temperature of the composition is adjusted to a temperature of from about 65° C. to about 110° C. and a pH of about 7 to about 12 for from about 15 seconds to about 240 minutes, prior to the composition being applied to the fibrous web and/or drum dryer.

20. The method according to claim 17, wherein the composition is applied to the drum dryer by spraying, brushing, rolling, foam applications, and combinations thereof.
